(19) United States
(12) Patent Application Publication
(10) Pub. No.: US 2022/0194132 A1
(43) Pub. Date: Jun. 23, 2022

(54) Tire for Agricultural Vehicle Comprising an Improved Tread

(71) Applicant: COMPAGNIE GENERALE DES ETABLISSEMENTS MICELIN, Clermont-Ferrand (FR)

(72) Inventors: Frédéric PERRIN, Clermont-Ferrand Cedex 9 (FR); Florian LACHAL, Clermont-Ferrand Cedex 9 (FR); Jean-Michel VACHERAND, Clermont-Ferrand Cedex 9 (FR)

(21) Appl. No.: 17/599,269

(22) PCT Filed: Mar. 26, 2020
(86) PCT No.: PCT/EP2020/058604

§ 371 Date: Sep. 28, 2021

(30) Foreign Application Priority Data
Mar. 29, 2019 (FR) FR1903318

(51) Int. Cl. B60C 11/03

(52) U.S. Cl. CPC B60C 11/033; B60C 2200/08; B60C 11/0302; B60C 11/0309

(57) ABSTRACT

A tire for an agricultural vehicle with a metal crown reinforcement, with improved endurance of the crown reinforcement thereof through the choice of a suitable tread. For each tread portion (21), positioned axially, with respect to the equatorial plane (E) of the tire (1), at an axial distance DE at most equal to 0.36*L, and having an axial width LE equal to 0.08*L, the product TEVL*(H/B) of the local volumetric void ratio of the tread portion (21) and the circumferential slenderness H/B of each tread pattern element (22) of said tread portion (21) is at most equal to 0.35.

The present invention relates to a tire for an agricultural vehicle, such as an agricultural tractor or an agri-industrial vehicle, and relates more particularly to the tread thereof.

The dimensional specifications and conditions of use (load, speed, pressure) of a tire for an agricultural vehicle are defined in standards, such as, for example, the ETRTO (European Tire and Rim Technical Organisation) standard. By way of example, a radial tire for a driven wheel of an agricultural tractor is intended to be mounted on a rim of which the diameter is generally comprised between 16 inches and 46 inches, or even 54 inches. It is intended to be run on an agricultural tractor of which the power is comprised between 50 CV and more than 250 CV (up to 550 CV) and able to run at up to 65 km/h. For this type of tire, the minimum recommended inflation pressure corresponding to the indicated loading capacity is usually at most equal to 400 kPa, but may drop as low as 240 kPa for an IF (Improved Flexion) tire, or even 160 kPa for a VF (Very high Flexion) tire.

Like any tire, a tire for an agricultural vehicle comprises a tread intended to come into contact with the ground via a tread surface—a surface making contact with firm ground—and the two axial ends of which are connected via two sidewalls to two beads that provide the mechanical connection between the tire and the rim on which it is intended to be mounted.

In the following text, the circumferential, axial and radial directions refer to a direction tangential to the tread surface and oriented in the direction of rotation of the tire, to a direction parallel to the axis of rotation of the tire, and to a direction perpendicular to the axis of rotation of the tire, respectively. A meridian or radial plane is defined by a radial direction and the axial direction and contains the axis of rotation of the tire. A circumferential plane is defined by a radial direction and a circumferential direction and is therefore perpendicular to the axis of rotation of the tire. The circumferential plane that passes through the middle of the tread is known as the equatorial plane.

The tread of a tire for an agricultural vehicle generally comprises raised elements, known as tread block elements, extending radially outward from a bearing surface as far as the tread surface, and separated from one another by voids.

The proportion of voids is usually quantified by a volumetric void ratio TEV, defined as the ratio between the volume of voids VC and the total volume of the tread assumed to be free of voids V, the total volume being the geometric volume delimited by the bearing surface and by the tread surface. As the tread surface varies according to the degree of wearing of the tread, the volumetric void ratio TEV will generally, although not necessarily, vary with the degree of wear. Thus, the volumetric void ratio TEV may be defined for the tire when new or in a given state of wear. By way of example, a tire for a driven wheel of an agricultural tractor when new has a volumetric void ratio TEV that is generally at least equal to 50% and often at least equal to 60%.

A local volumetric void ratio TEVL may also be defined for any portion of tread extending circumferentially over the entire circumference of the tire and extending axially from a first circumferential plane to a second circumferential plane, the distance between these two circumferential planes defining the axial width of the tread portion. The local volumetric void ratio TEVL is defined as being the ratio between the volume of voids VCL and the total volume VL of the tread portion assumed to be free of voids, which corresponds to the geometric volume delimited by the bearing surface, the tread surface, and the two circumferential planes. Like the volumetric void ratio TEV, the local volumetric void ratio TEVL may be defined for the tire when new or in a given state of wear.

Moreover, for a tire in the new state or in a state of wear, in any circumferential plane perpendicular to the axis of rotation of the tire, it is possible to determine a circumferential void ratio TEC, measured along the curve of intersection between the circumferential plane and the tread surface. This circumferential void ratio TEC is defined as being the ratio between the circumferential void length LC, which corresponds to the cumulative width of the voids intersected by the circumferential plane and measured in the tread surface, and the total circumferential length L, which corresponds to the length of the curve of intersection between the circumferential plane and the tread surface.

Each tread pattern element can be geometrically characterized by a radial height H in a radial direction, an axial width A in an axial direction, and a circumferential length B in a circumferential direction. These three dimensions H, A and B are mean values, in the knowledge that these can vary according to the measurement points selected on the tread pattern element. Regarding the axial width A and the circumferential length B, these may increase from the tread surface as far as the bearing surface at the bottom of the void, because of the presence of backrake angles. Regarding the radial height H, for a radial tire for a driven wheel of an agricultural tractor, the radial height H of a tread pattern element is generally at least equal to 50 mm and more generally at least equal to 60 mm From these three dimensions H, A and B, there may be defined, for a given tread pattern element, a circumferential slenderness H/B, an axial slenderness H/A and a surface-area aspect ratio B/A.

A tread for an agricultural vehicle usually comprises tread aspect ratios in the form of lugs. A lug generally has an elongate shape that is parallelepipedal overall, is continuous or discontinuous, and is made up of at least one rectilinear or curvilinear portion. A lug is separated from the adjacent lugs by voids or grooves. A lug extends axially from a median zone of the tread as far as the axial ends or shoulders thereof. A lug comprises a contact face, positioned in the tread surface and intended to come fully into contact with the ground, a leading face that intersects the tread surface and of which the arris of intersection therewith is intended to be first to come into contact with the ground, a trailing face that intersects the tread surface and of which the arris of intersection therewith is intended to be last to come into contact with the ground, and two lateral faces.

The lugs are distributed circumferentially with a spacing that is constant or variable and are generally disposed on each side of the equatorial plane of the tire so as to form a V-shaped pattern, the tip of the V-shaped pattern (or chevron pattern) being intended to be the first part to enter the contact patch in which contact is made with the ground. The lugs generally exhibit symmetry with respect to the equatorial plane of the tire, usually with a circumferential offset between the two rows of lugs, obtained by one half of the tread being rotated about the axis of the tire with respect to the other half of the tread.

A radial tire for an agricultural vehicle further comprises a reinforcement made up of a crown reinforcement radially on the inside of the tread and of a carcass reinforcement radially on the inside of the crown reinforcement.

The carcass reinforcement of a radial tire for an agricultural vehicle comprises at least one carcass layer connecting the two beads to one another. The reinforcers of a carcass layer are substantially mutually parallel and form an angle of between 75° and 105°, preferably between 85° and 95°, with the circumferential direction. A carcass layer comprises reinforcers, usually textile reinforcers, coated with a polymer material of the elastomer or elastomeric type and referred to as the skim compound.

The crown reinforcement of a radial tire for an agricultural vehicle comprises a superposition of circumferentially extending crown layers, radially on the outside of the carcass reinforcement. Each crown layer is made up of reinforcers which are coated in an elastomer compound and mutually parallel. When the crown layer reinforcers form, with the circumferential direction, an angle at most equal to 10°, they are referred to as circumferential, or substantially circumferential, and perform a hooping function that limits the radial deformations of the tire. When the crown layer reinforcers form, with the circumferential direction, an angle at least equal to 10° and usually at most equal to 30°, they are referred to as angled reinforcers, and have a function of reacting the transverse loads, parallel to the axial direction, that are applied to the tire. The crown layer reinforcers may be made up of textile-type polymer materials, such as a polyester, for example a polyethylene terephthalate (PET), an aliphatic polyamide, for example a nylon, an aromatic polyamide, for example aramid, or else rayon, or may be made up of metallic materials such as steel, or any combination of the abovementioned materials.

A tire for an agricultural vehicle is intended to run over various types of ground such as the more or less compact soil of the fields, unmade tracks providing access to the fields, and the tarmacked surfaces of roads. Bearing in mind the diversity of use, in the field and on the road, a tire for an agricultural vehicle needs to offer a performance compromise between traction in the field on loose ground, resistance to chunking, resistance to wear on the road, resistance to forward travel, and vibrational comfort on the road, this list not being exhaustive.

One essential problem in the use of a tire in the field is that of limiting, as far as possible, the extent to which the soil is compacted by the tire, as this is liable to hamper crop growth.

This is why, in the field of agriculture, low-pressure and therefore high-flexion tires have been developed. The ETRTO standard thus makes a distinction between IF (Improved Flexion) tires, which have a minimum recommended inflation pressure generally equal to 240 kPa, and VF (Very high Flexion) tires, which have a minimum recommended inflation pressure generally equal to 160 kPa. According to that standard, by comparison with a standard tire, an IF tire has a 20% higher load-bearing capability and a VF tire has a 40% higher load-bearing capability, for an inflation pressure equal to 160 kPa.

However, the use of low-pressure tires has had a negative impact on the handling in the field. Thus, the lowering of the inflation pressure has led to a reduction in the transverse and cornering stiffnesses of the tire, thus reducing the transverse thrust of the tire and therefore resulting in inferior handling under transverse loads.

One solution for re-establishing the correct transverse thrust has been to stiffen the crown reinforcement of the tire transversely, by replacing the crown layers having textile reinforcers with crown layers having metal reinforcers. Thus, for example, a crown reinforcement comprising 6 crown layers with textile reinforcers of the Rayon type has been replaced with a crown reinforcement comprising 2 crown layers with reinforcers made of steel. Document EP 2934917 thus describes an IF tire comprising a crown reinforcement comprising at least two crown layers having metal reinforcers, which is combined with a carcass reinforcement comprising at least two carcass layers having textile reinforcers.

However, the use of crown layers having metal reinforcers, in a tire for an agricultural vehicle, may lead to a reduction in the endurance of the crown of the tire, as a result of premature breakage of the metal reinforcers.

In order to limit these problems with crown endurance, tire manufacturers have proposed the return, in the case of crown layers with metal reinforcers, to a recommended service pressure that is higher than that recommended in the case of carcass layers having textile reinforcers. For example, it has been possible to recommend inflating a tire having crown layers with metal reinforcers to a pressure equal to 2.7 bar, rather than the 2 bar that is the recommended pressure for a tire having crown layers with textile reinforcers and intended to run under the same load and speed conditions, this namely representing an increase of 35%. This solution, based on an increase in the inflation pressure, is unsatisfactory, because increasing the pressure impairs performance in terms of the compaction of loose ground.

The inventors have therefore set themselves the objective of increasing the endurance of a crown reinforcement comprising metal reinforcers up to a level at least equivalent to that of a crown reinforcement comprising textile reinforcers, particularly for a tire for an agricultural vehicle operating at low pressure, such as an IF (Improved Flexion) tire or a VF (Very high Flexion) tire.

This objective has been achieved, according to the invention, with a tire for an agricultural vehicle, having a nominal section width L, within the meaning of the ETRTO standard, and comprising, radially from the outside to the inside, a tread and a crown reinforcement;

the tread comprising tread pattern elements that are separated from one another by voids and extend radially towards the outside from a bearing surface to a tread surface,

the tread having a volumetric void ratio TEV, defined as the ratio between the volume of voids VC and the total volume of the tread assumed to be free of voids V, comprised between the bearing surface and the tread surface,

each tread pattern element having a circumferential slenderness H/B, H being the mean radial height between the bearing surface and the tread surface and B being the mean circumferential length of the tread pattern element,

each tread portion, positioned axially, with respect to an equatorial plane of the tire, at an axial distance DE, having an axial width LE and a local volumetric void ratio TEVL, defined as being the ratio between the volume VCL of the voids and the total volume VL of said tread portion, comprised between the bearing surface and the tread surface,

the crown reinforcement comprising at least two crown layers each comprising metal reinforcers which are coated in an elastomeric material, are mutually parallel and form an angle at least equal to 10° with a circumferential direction,

for each tread portion, positioned axially, with respect to the equatorial plane of the tire, at an axial distance DE at most equal to 0.36*L, and having an axial width LE equal to 0.08*L, the product TEVL*(H/B) of the local volumetric void ratio of the tread portion and the circumferential slenderness H/B of each tread pattern element of said tread portion being at most equal to 0.35.

The principle behind the invention is therefore that of proposing a tire for an agricultural vehicle, having a crown reinforcement with metal reinforcers and comprising a tread with specific local geometric characteristics and volumetric void ratio TEV.

The local geometric characterisation of the tread is defined for tread portions extending circumferentially over the entire circumference of the tire and having a width LE that, by convention, is equal to 0.08*L, namely to 8% of the nominal section width L of the tire. By definition, the nominal section width L of the tire, within the meaning of the ETRTO standard, is the width used in the naming convention for the tire: for example, a tire of dimension 600/70 R 30 has a nominal section width equal to 600 mm

Furthermore, each tread portion is positioned axially, with respect to the equatorial plane which is the circumferential plane that passes through the middle of the tread, at an axial distance DE defined as being the axial distance between the circumferential mid-plane of the tread portion and the equatorial plane of the tire. In the context of the invention, the tread portions taken into consideration are those positioned axially at an axial distance DE at most equal to 0.36*L, namely at 36% of the nominal section width L of the tire. As a result, the tread portions taken into consideration are comprised within a working zone of the tread, centred on the equatorial plane and corresponding to 80% of the nominal section width L of the tire.

Furthermore, each tread portion is characterized by a local volumetric void ratio TEVL, defined as being the ratio between the volume VCL of the voids and the total volume VL of said tread portion, comprised between the bearing surface and the tread surface. Moreover, each tread pattern element of said tread portion is characterized by a circumferential slenderness H/B, H being the mean radial height between the bearing surface and the tread surface and B being the mean circumferential length of the tread pattern element.

According to the invention, for each tread portion, positioned axially, with respect to the equatorial plane of the tire, at an axial distance DE at most equal to 0.36*L, and having an axial width LE equal to 0.08*L, the product TEVL*(H/B) of the local volumetric void ratio of the tread portion and the circumferential slenderness H/B of each tread pattern element of said tread portion is at most equal to 0.35. This criterion defines, for any tread portion as previously defined, a combination between the local volumetric void ratio TEVL and the circumferential slenderness H/B of the tread pattern elements of said tread portion that makes it possible to limit the tilting of the tread pattern elements in the circumferential dimension.

The inventors have demonstrated that a tread according to the invention, characterized by tread pattern elements said to exhibit low circumferential tilt, contributes to improving the endurance of the crown reinforcement of the tire comprising metal reinforcers.

Specifically, when a tire for an agricultural vehicle, comprising a lugged tread, and more generally comprising tread pattern elements of great radial height, is being driven on, the tilting of the lugs under (driving or braking) torque causes the crown layers positioned radially on the inside of the lugs to tilt. This tilting leads to curvatures, which alternate between positive and negative, of the crown layers, and correspondingly to alternating cycles of compressive/tensile loadings of the metal reinforcers of the crown layers, which are liable to cause fatigue failure of said metal reinforcers under the action of these reverse-cycle bending stresses.

This phenomenon of tilting is all the more pronounced when the inflation pressure of the tire is low and is therefore particularly critical for tires of agricultural vehicles operating at low pressure, such as IF (Improved Flexion) or VF (Very high Flexion) tires.

It should also be noted that the crown layers of a tire for an agricultural vehicle generally have initial curvatures, both in the circumferential direction and in the axial direction, as a result of the movements of the various elastomeric components and of the reinforcers during the course of manufacture, as the tire is being moulded and cured. These initial deformations combine with the deformations resulting from the tilting of the tread pattern elements and therefore likewise contribute to the cyclic compressive/tensile loadings of the metal reinforcers of the crown layers as the tire is being driven on.

Thus, tread pattern elements with low circumferential tilting according to the invention induce, in the metal reinforcers of the crown layer, cycles of compressive/tensile loading of limited amplitude, hence improving the endurance of the crown reinforcement of the tire and therefore increasing the life of the tire.

As a preference, the volumetric void ratio TEV of the tread is at least equal to 35%. For a tire for an agricultural vehicle of the prior art, the volumetric void ratio TEV is generally at least equal to 50% and often at least equal to 60%. For a tire according to the invention, the volumetric void ratio TEV is generally lower, and may drop as low as 35% to compensate for the reduction in the volume of material caused by the reduction in the mean radial height of the tread pattern elements.

Advantageously, the mean radial height H of each tread pattern element is at least equal to 20 mm Such a minimum value for the mean radial height H makes it possible to obtain a compromise between the limited tilting of the tread pattern elements and a sufficient volume of material that can be worn away, and therefore a compromise between traction capabilities and life in terms of tire wear.

Advantageously also, the mean radial height H of each tread pattern element is at most equal to 50 mm A mean radial height H limited in this way also contributes to limiting the tilting of the tread pattern elements and therefore to increasing the endurance of the crown reinforcement.

As a preference, in any circumferential plane positioned axially at 0.4*L at most, the circumferential void ratio TEC1 when new is at least equal to 1.45 times the circumferential void ratio TEC2 in the worn state. By definition, in a given circumferential plane, the circumferential void ratio TEC1 when new is measured along the curve of intersection between the circumferential plane and the tread surface when new and is defined as being the ratio between the circumferential void length LC1 and the total circumferential length L1. Similarly, in this same circumferential plane, the circumferential void ratio TEC2 in the worn state is measured along the curve of intersection between the circumferential plane and the tread surface when worn, the tread surface in the worn state being positioned radially on the outside of the bearing surface at a radial distance HR, and is defined as being the ratio between the circumferential void length LC2 and the total circumferential length L2. The radial distance HR is the residual height of the corresponding tread pattern element in the worn state at the end of life of the tire before it is removed from the vehicle, and is generally equal to 10 mm

According to this criterion, in any circumferential plane, the void length, when new, is therefore greater than the void length when worn. In other words, the circumferential length of any tread pattern element intended to come into contact with the ground increases as the tire progresses from the new state to the worn state. This criterion is indicative of the flaring, in the circumferential direction, of the tread pattern elements towards the inside, namely the presence of angles or backrake angles at the leading and trailing faces of the tread pattern elements. This shape of tread pattern element contributes to stiffening the tread pattern element in terms of circumferential bending and therefore to reducing the extent to which it tilts.

According to a first way of distributing the tread pattern elements, for a tire of which the tread is made up of at least 5 circumferential rows of tread pattern elements that are separated from one another by substantially circumferential voids extending around the entire circumference of the tire, the tread comprises transverse voids extending continuously from one axial edge of the tread to the other. A void is said to be substantially circumferential when its mean axis forms, with the circumferential direction, an angle at most equal to 45° and usually at most equal to 10°. More specifically, on either side of the equatorial plane of the tire, the tread pattern elements, the base of which is more or less quadrilateral in shape, together form motifs that are inclined in the form of chevrons with respect to the circumferential direction. Within each motif, the tread pattern elements are disposed such that their leading faces are aligned with one another, meaning that together they are almost continuous, being interrupted only by circumferential voids. As a result, the tread pattern elements are not circumferentially offset from one row to the other.

According to a second way of distributing the tread pattern elements, for a tire of which the tread is made up of at least 5 circumferential rows of tread pattern elements that are separated from one another by substantially circumferential voids extending around the entire circumference of the tire, the tread comprises transverse voids extending discontinuously from one axial edge of the tread to the other, such that the tread pattern elements of a given circumferential row have an angular offset in the circumferential direction with respect to those of an adjacent row. As before, on either side of the equatorial plane of the tire, the tread pattern elements, the base of which is more or less quadrilateral in shape, together form motifs that are inclined in the form of chevrons with respect to the circumferential direction. However, within each motif, the tread pattern elements are disposed in such a way that their leading faces are circumferentially offset from one another. As a result, the tread pattern elements are circumferentially offset from one row to the other.

According to one particular and advantageous way of distributing the tread pattern elements, the tread comprises a total number N of tread pattern elements, each tread pattern element comprising a contact face, a leading face and a trailing face, said leading face being inclined by an angle α towards the rear with respect to the radial direction in the direction of running of the tread, said tread comprising a number N1 of tread pattern elements for which the angle α is comprised between 50 degrees and 75 degrees, the number N1 being at least equal to 0.2×N.

In other words, at least 20% of the tread pattern elements have a leading face with a backrake angle of between 50° and 75°. This feature of inclining the leading face of a significant proportion of the tread pattern elements provides both an appreciable improvement in terms of traction on loose ground and an improvement in terms of circumferential bending stiffness, limiting the tilting of the tread pattern element.

According to one particular and advantageous embodiment of the crown reinforcement, any metal reinforcer of a crown layer has a law, known as a bi-modulus law, governing its elastic behaviour under tension, and comprising a first portion having a first extension modulus MG1 at most equal to 30 GPa, and a second portion having a second extension modulus MG2 at least equal to 2 times the first extension modulus MG1, said law governing the tensile behaviour being determined for a metal reinforcer coated in an elastomer compound having a tensile elastic modulus at 10% elongation, MA10, at least equal to 5 MPa and at most equal to 15 MPa, and any metal reinforcer of a crown layer (31, 32) has a law governing its behaviour under compression that is characterized by a critical buckling strain E0 at least equal to 3%, said law governing behaviour under compression being determined on a test specimen made up of a reinforcer placed at its centre and coated with a parallelepipedal volume of an elastomer compound having a tensile elastic modulus at 10% elongation, MA10, at least equal to 5 MPa and at most equal to 15 MPa.

In this particular embodiment, the inventors are therefore proposing the use, in combination with a tread according to the invention, of elastic metal reinforcers for which the laws governing their behaviour have specific characteristics both in extension and in compression.

As regards its behaviour under tension, a bare metal reinforcer, which is to say one not coated with an elastomer material, is mechanically characterized by a curve representing the tensile force (in N) applied to the metal reinforcer as a function of the relative elongation (% strain) thereof, known as the force-elongation curve. Mechanical tensile characteristics of the metal reinforcer, such as the structural elongation As (in %), the total elongation at break At (in %), the force at break Fm (maximum load in N) and the breaking strength Rm (in MPa) are derived from this force-elongation curve, these characteristics being measured, for example, in accordance with the standard ISO 6892 of 1984, or the standard ASTM D2969-04 of 2014.

In the context of the invention, the law governing the tensile behaviour of a metal reinforcer is determined for a metal reinforcer coated in a cured elastomer material, corresponding to a metal reinforcer extracted from the tire, on the basis of the standard ISO 6892 of 1984, as for a bare metal reinforcer. By way of example, and nonlimitingly, a cured elastomer skim coating material is a rubber-based composition having a secant extension elastic modulus at 10% elongation, MA10, at least equal to 5 MPa and at most equal to 15 MPa, for example equal to 6 MPa. This tensile elastic modulus is determined from tensile testing performed in accordance with French Standard NF T 46-002 of September 1988.

From the force-elongation curve, for a bi-modulus elastic behaviour law comprising a first portion and a second portion, it is possible to define a first tensile stiffness KG1 representing the gradient of the secant straight line passing through the origin of the frame of reference in which the behaviour law is represented, and the transition point marking the transition between the first and second portions. Likewise, it is possible to define a second tensile stiffness KG2 representing the gradient of a straight line passing through two points positioned in a substantially linear part of the second portion.

From the force-elongation curve that characterizes the tensile behaviour of a reinforcer, it is also possible to define a stress-strain curve, the stress being equal to the ratio between the tensile force applied to the reinforcer and the cross-sectional area of the reinforcer, and the strain being the relative elongation of the reinforcer. For a bi-modulus elastic behaviour law comprising a first portion and a second portion, it is possible to define a first extension modulus MG1 representing the gradient of the secant straight line passing through the origin of the frame of reference in which the behaviour law is represented, and the transition point marking the transition between the first and second portions. Likewise, it is possible to define a second extension modulus MG2 representing the gradient of a straight line passing through two points positioned in a substantially linear part of the second portion. The tensile stiffnesses KG1 and KG2 are respectively equal to MG1*S and MG2*S, S being the cross-sectional area of the reinforcer.

Regarding the tensile behaviour of the metal reinforcers, any metal reinforcer of a crown layer has a law, known as a bi-modulus law, governing its elastic behaviour under tension, comprising a first, so-called low-modulus, portion having a first extension modulus MG1 at most equal to 30 GPa, and a second, so-called high-modulus, portion having a second extension modulus MG2 at least equal to 2 times the first extension modulus MG1.

As regards the behaviour under compression, a metal reinforcer is mechanically characterized by a curve representing the compression force (in N) applied to the metal reinforcer as a function of the compression strain thereof (in %). Such a compression curve is particularly characterized by a limit point, defined by a critical buckling force Fc, and a critical buckling strain E0, beyond which the reinforcer experiences compressive buckling, corresponding to a state of mechanical instability characterized by large amounts of deformation of the reinforcer with a reduction in the compressive force.

The law governing the behaviour in compression is determined, using a test machine of the Zwick or Instron type, on a test specimen measuring 12 mm×21 mm×8 mm (width×height×thickness). The test specimen consists of a reinforcer placed at its centre and coated with a parallelepipedal volume of an elastomer compound defining the volume of the test specimen, the axis of the reinforcer being positioned along the height of the test specimen. In the context of the invention, the elastomer compound of the test specimen has a secant extension elastic modulus at 10% elongation, MA10, at least equal to 5 MPa and at most equal to 15 MPa, for example equal to 6 MPa. The test specimen is compressed in the heightwise direction, at a rate of 3 mm/min until compressive deformation is achieved, namely until the test specimen is compressed by an amount equal to 10% of its initial height, at ambient temperature. The critical buckling force Fc and the corresponding critical buckling strain E0 are reached when the applied force decreases while the strain continues to increase. In other words, the critical buckling force Fc corresponds to the maximum compression force Fmax.

Regarding the compressive behaviour of the metal reinforcers, any metal reinforcer of a crown layer has a law governing its behaviour under compression that is characterized by a critical buckling strain E0 at least equal to 3%.

The inventors have demonstrated that metal reinforcers referred to as being elastic, characterized by laws as described hereinabove governing their behaviour under tension and under compression, have a fatigue endurance limit, during repeated alternating cycles of tensile/compressive loadings, that is higher than that of the usual metal reinforcers.

In conclusion, the combination of a tread comprising tread patent elements with a low circumferential tilt, and of a crown reinforcement comprising elastic metal reinforcers with laws such as described hereinabove governing their behaviour under tension and under compression, allows the endurance of the crown to be improved still further.

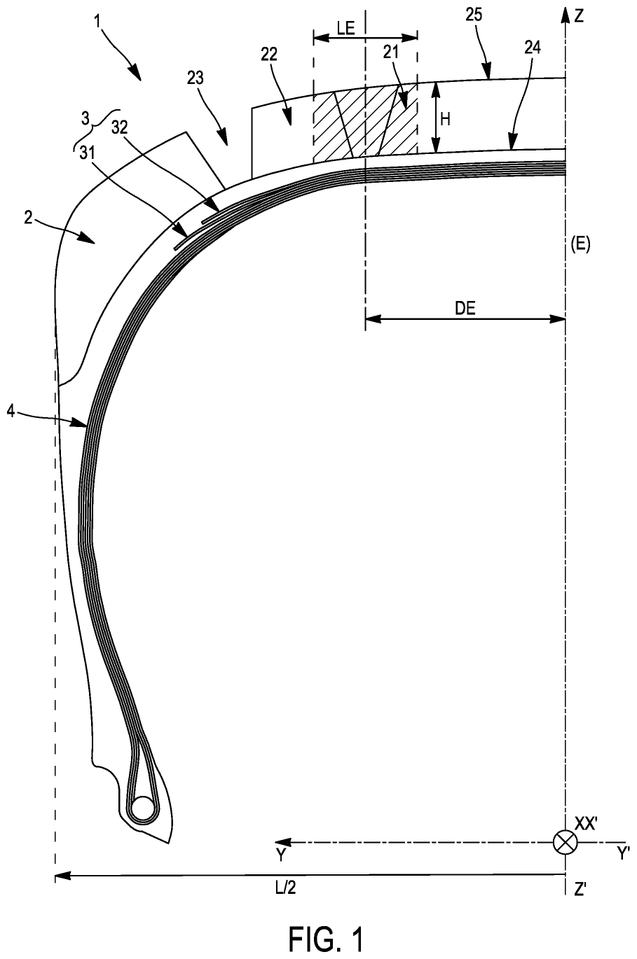

The features of the invention are illustrated by the schematic FIGS. 1 to 12, which are not drawn to scale:

FIG. 1: Meridian half-section of a tire for an agricultural vehicle according to the invention

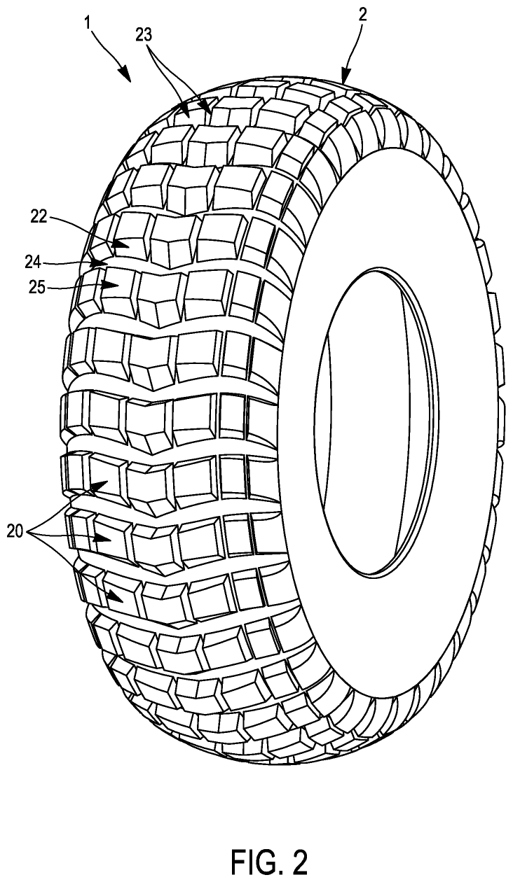

FIG. 2: Perspective view of a tire for an agricultural vehicle according to a first embodiment of the invention

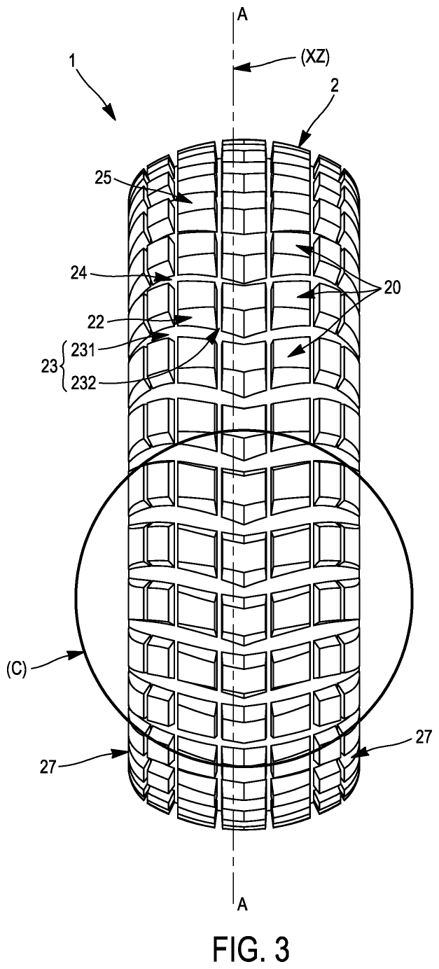

FIG. 3: Face-on view of a tire for an agricultural vehicle according to a first embodiment of the invention

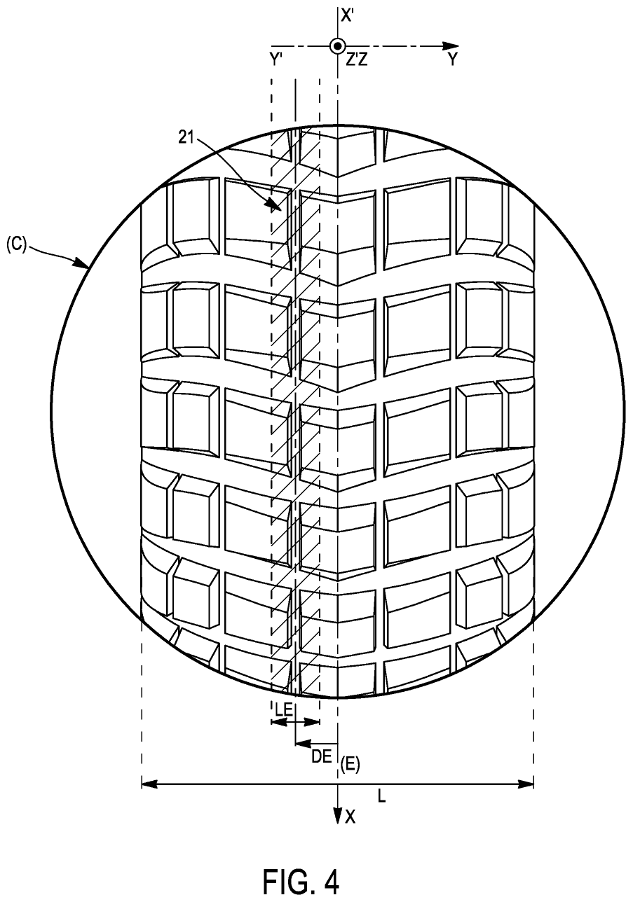

FIG. 4: Detail of the tread of a tire for an agricultural vehicle according to a first embodiment of the invention

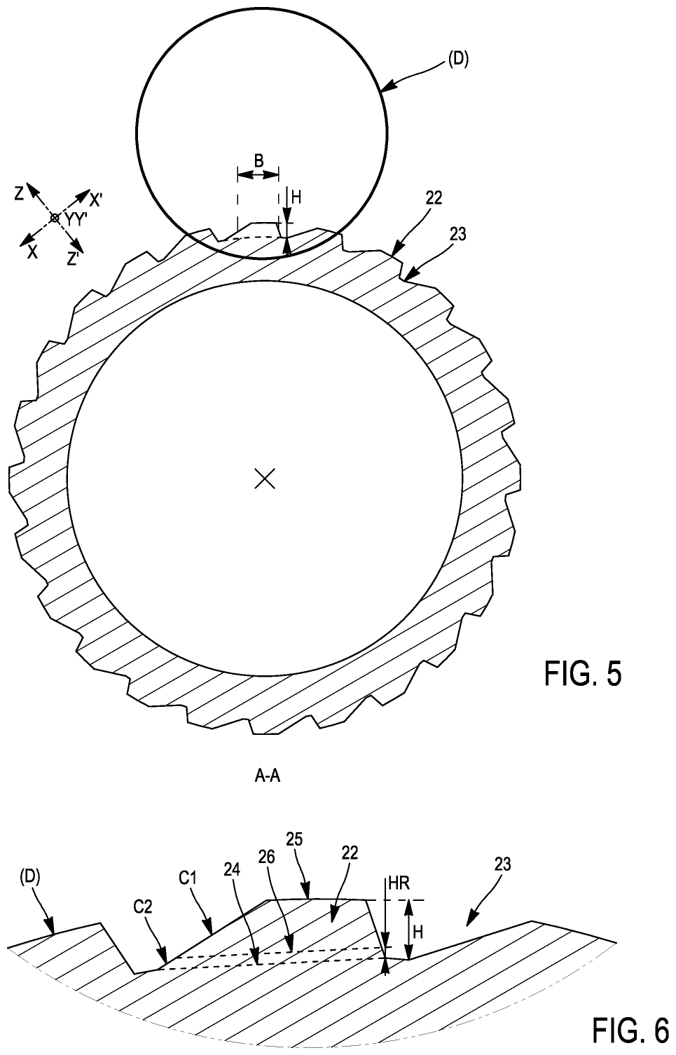

FIG. 5: Circumferential section through the tread of a tire for an agricultural vehicle according to a first embodiment of the invention

FIG. 6: Detail of the circumferential section through the tread of a tire for an agricultural vehicle according to a first embodiment of the invention

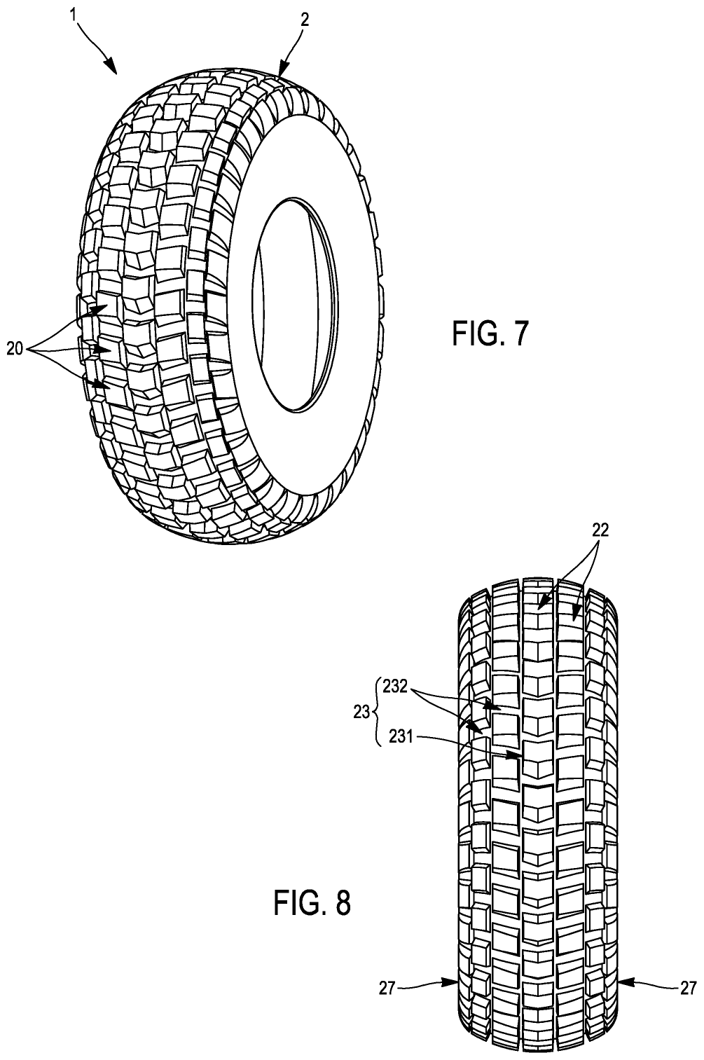

FIG. 7: Perspective view of a tire for an agricultural vehicle according to a second embodiment of the invention

FIG. 8: Face-on view of a tire for an agricultural vehicle according to a second embodiment of the invention

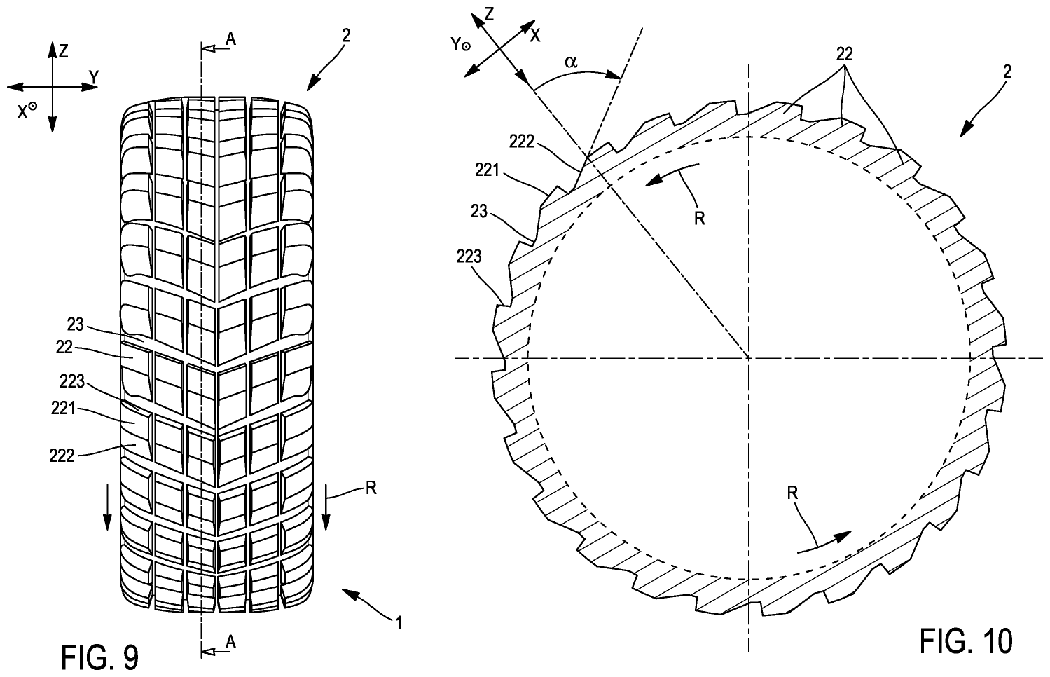

FIG. 9: Face-on view of a tire for an agricultural vehicle according to a third embodiment of the invention

FIG. 10: Circumferential section through the tread of a tire for an agricultural vehicle according to a third embodiment of the invention

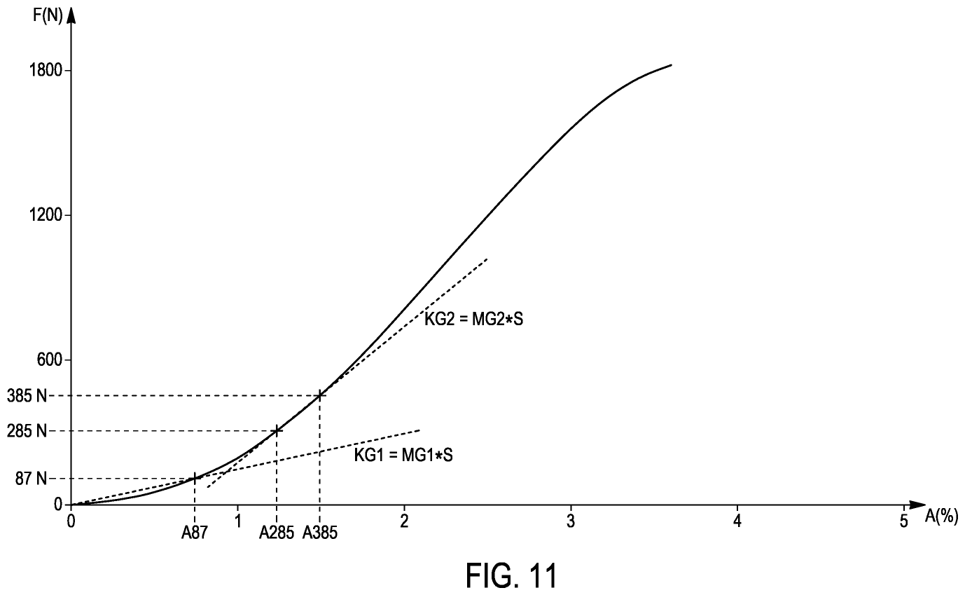

FIG. 11: Typical example of a typical tensile force-elongation curve for an elastic metal reinforcer coated with an elastomeric material

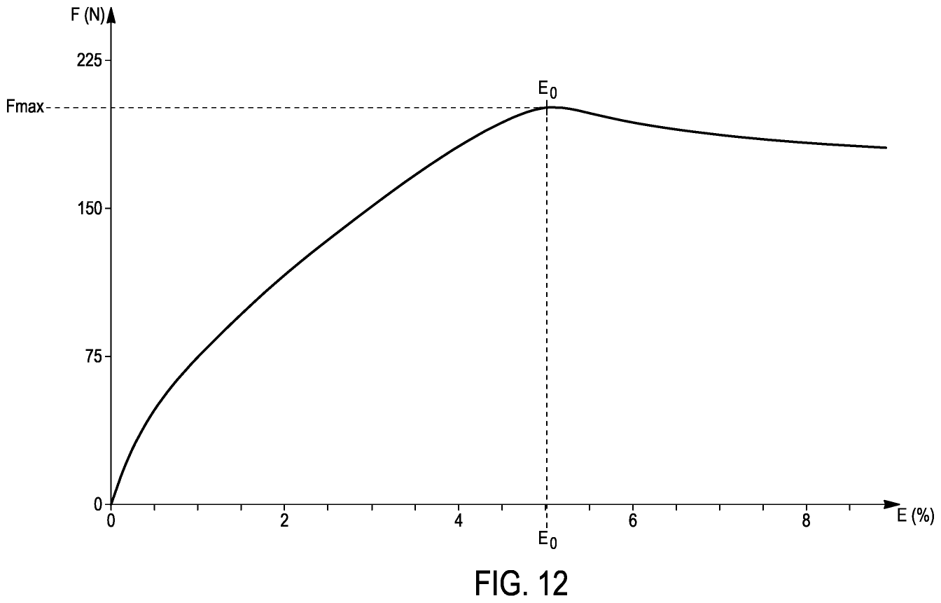

FIG. 12: Typical example of a compressive force-compressive strain curve for an elastic metal reinforcer, obtained on a test specimen made of elastomeric material

FIG. 1 depicts a half-view in meridian section of a tire 1 for an agricultural vehicle, in a meridian plane YZ passing through the axis of rotation YY′ of the tire. The tire 1 has a nominal section width L, within the meaning of the ETRTO standard—only a half-width L/2 is depicted—and comprises a crown reinforcement 3, radially on the inside of a tread 2 and radially on the outside of a carcass reinforcement 4. The crown reinforcement 3 comprises two crown layers (31, 32) each comprising metal reinforcers which are coated in an elastomeric material, are mutually parallel and form an angle (not depicted) at least equal to 10° with a circumferential direction XX′. The crown reinforcement 4 comprises three carcass layers comprising textile reinforcers that are coated in an elastomeric material, are mutually parallel and form an angle (not depicted) at least equal to 85° and at most equal to 95° with the circumferential direction XX′. The tread 2 comprises tread pattern elements 22 that are separated from one another by voids 23 and extend radially towards the outside from a bearing surface 24 to a tread surface 25. Also depicted, with hatching, is a tread portion 21, positioned axially, with respect to the equatorial plane E of the tire, at an axial distance DE at most equal to 0.36*L, and having an axial width LE equal to 0.08*L. According to the invention, for such a tread portion 21, the product TEVL*(H/B) of the local volumetric void ratio of the tread portion 21 and the circumferential slenderness H/B of each tread pattern element 22 of said tread portion 21 is at most equal to 0.35. The local volumetric void ratio TEVL is defined as being the ratio between the volume VCL of the voids 23 and the total volume VL of said tread portion 21, comprised between the bearing surface 24 and the tread surface 25. The circumferential slenderness H/B is the ratio between the mean radial height H between the bearing surface 24 and the tread surface 25 and B being the mean circumferential length (not depicted) of the tread pattern element 22.

FIGS. 2 and 3 are, respectively, a perspective view and a face-on view of a tire 1 for an agricultural vehicle according to a first embodiment of the invention. According to this first embodiment, the tread 2 is made up of seven circumferential rows 20 of tread pattern elements 22 extending radially outward from a bearing surface 24 as far as the tread surface 25, and separated from one another by voids 23. The voids 23 are either circumferential voids 231 extending around the entire circumference of the tire, or transverse voids 232 extending continuously from one axial edge 27 of the tread to the other. In the case depicted, the tread pattern elements constitute chevron motifs. FIG. 3 depicts the detail C of the tread, which forms the subject of FIG. 4, and the circumferential plane XZ, according to the circumferential section A-A, that forms the subject of FIG. 5.

FIG. 4 is a detail of the tread of a tire 1 for an agricultural vehicle according to the first embodiment of the invention. This detail C depicts, in particular, in the form of hatching, a tread portion 21, positioned axially, with respect to the equatorial plane E of the tire, at an axial distance DE at most equal to 0.36*L, and having an axial width LE equal to 0.08*L, for which, according to the invention, the product TEVL*(H/B) of the local volumetric void ratio of the tread portion 21 and the circumferential slenderness H/B of each tread pattern element 22 of said tread portion 21 is at most equal to 0.35.

FIG. 5 is a circumferential section through the tread of a tire for an agricultural vehicle according to the first embodiment of the invention. Depicted on this section A-A are the mean radial height H between the bearing surface 24 and the tread surface 25, and the mean circumferential length B of the tread pattern element 22, extending radially towards the outside from a bearing surface 24 as far as a tread surface 25. The mean circumferential length B is the mean distance separating the leading face and the trailing face of the tread pattern element 22.

FIG. 6 is a detail of the circumferential section through the tread of a tire for an agricultural vehicle according to the first embodiment of the invention. This detail D depicts a tread pattern element 22, separated from the adjacent tread pattern elements by voids 23. In a given circumferential plane XZ, the curve C1 of intersection between the circumferential plane XZ and the tread surface 25 when new can be used to define a circumferential void ratio TEC1 when new, this being defined as being the ratio between the circumferential void length LC1 and the total circumferential length L1, the tread surface 25 when new being positioned radially on the outside of the bearing surface 24 at a radial distance H. Similarly, the curve C2 of intersection between the circumferential plane XZ and the tread surface 26 when worn can be used to define a circumferential void ratio TEC2 when worn, this being defined as being the ratio between the circumferential void length LC2 and the total circumferential length L2, the tread surface 26 when worn being positioned radially on the outside of the bearing surface 24 at a radial distance HR. Advantageously, the circumferential void ratio TEC1 when new is at least equal to 1.45 times the circumferential void ratio TEC2 in the worn state.

FIGS. 7 and 8 are, respectively, a perspective view and a face-on view of a tire 1 for an agricultural vehicle according to a second embodiment of the invention. According to this second embodiment, the tread 2 is made up of seven circumferential rows 20 of tread pattern elements 22 separated from one another by voids 23. The voids 23 are either circumferential voids 231 extending over the entire circumference of the tire, or transverse voids 232 extending discontinuously from one axial edge 27 of the tread 2 to the other so that the tread pattern elements 22 of a given circumferential row 20 are angularly offset in the circumferential direction relative to those of an adjacent row.

FIG. 9 is a face-on view of a tire 1 for an agricultural vehicle according to a third embodiment of the invention. In this third embodiment, the tread 2 comprises a total number N of tread pattern elements 22, each tread pattern element 22 comprising a contact face 221, a leading face 222 and a trailing face 223, said leading face being inclined by an angle α towards the rear with respect to the radial direction ZZ′ in the direction of running R of the tread 2, said tread 2 comprising a number N1 of tread pattern elements 22 for which the angle α is comprised between 50 degrees and 75 degrees, the number N1 being at least equal to 0.2×N. Each tread pattern element 22 therefore comprises a contact face 221, a leading face 222 and a trailing face 223. The contact face is the face, at the crown, of the tread pattern element 22 that is intended to roll and bear the load on firm ground. On loose ground, the tread pattern elements 22 can sink into the ground. In the preferred direction of running of the tire, the leading face 222 is thus the face that is the first to enter the contact patch and can transmit a driving force, while the trailing face is the face that is the last to leave the contact patch. The trailing face 223 can only transmit force to the ground during a braking or reversing phase.

FIG. 10 depicts the section A-A from the face-on view of the tire shown in FIG. 9. This section makes it possible to clearly see the orientation of the leading faces of the tread pattern elements 22. The leading faces are inclined with respect to the radial direction Z in the opposite direction to the preferred direction of running R and form an angle α with this radial direction Z. In this example, the angle α is equal to 60° and therefore comprised between 50° and 70°.

FIG. 11 is a typical example of a tensile force-relative elongation curve for an elastic metal reinforcer according to one particular embodiment of elastic metal reinforcer, coated with an elastomeric material, showing its elastic behaviour under tension. The tensile force F is expressed in N and the elongation A is a relative elongation expressed as a %. According to this embodiment, the elastic and bi-modulus law governing the behaviour under tension comprises a first portion and a second portion. The first portion is delimited by two points of which the ordinate values correspond respectively to a zero tensile force and to a tensile force equal to 87 N, the respective abscissa values being the corresponding relative elongations (in %). A first tensile stiffness KG1 may be defined, this representing the gradient of the secant straight line passing through the origin of the frame of reference in which the behaviour law is represented, and the transition point marking the transition between the first and second portions. With the knowledge that, by definition, the tensile stiffness KG1 is equal to the product of the extension modulus MG1 times the cross-sectional area S of the reinforcer, the extension modulus MG1 can easily be deduced from it. The second portion is the collection of points corresponding to a tensile force greater than 87 N. Likewise, for this second portion, a second tensile stiffness KG2 may be defined, this representing the gradient of a straight line passing through two points positioned in a substantially linear part of the second portion. In the example depicted, the two points have the respective ordinate values F=285 N and F=385 N, these tensile force values corresponding to levels of mechanical loading indicative of the loadings applied to the metal reinforcers of the crown layers when the tire being studied is being driven on. As described previously, KG2=MG2*S, and so the extension modulus MG2 can be deduced therefrom.

FIG. 12 is a typical example of a compressive force-compressive strain curve for an elastic metal reinforcer according to the particular embodiment of elastic metal reinforcer described hereinabove, showing its elastic behaviour under compression. The compressive force F is expressed in N and the compressive strain is a relative compression, expressed as a %. This compression-behaviour law, determined on a test specimen made of elastomeric compound having a secant extension elastic modulus at 10% elongation, MA10, equal to 6 MPa, exhibits a maximum corresponding to the onset of buckling of the reinforcer. This maximum is reached for a maximum compression force Fmax, or critical buckling force, corresponding to a critical buckling strain E0. Beyond the point of buckling, the compressive force applied decreases while the strain continues to increase. According to the invention, the critical buckling strain E0 is approximately equal to 5% and therefore greater than 3%.

The invention was implemented on a tire for an agricultural vehicle of dimension 600/70 R 30, having a nominal section width L equal to 600 mm and comprising a tread having a volumetric void ratio TEV equal to 50% and a crown reinforcement comprising two crown layers of which the reinforcers are elastic metal reinforcers of formulae E18.23 or E24.26.

For a tread portion such as that depicted in FIG. 4, positioned axially, with respect to the equatorial plane E of the tire, at an axial distance DE equal to 79 mm, and therefore less than 0.36*L=216 mm, and having an axial width LE equal to 0.08*L=48 mm, the local volumetric void ratio TEVL is equal to 63% and the circumferential slenderness H/B of any tread pattern element is equal to 0.36, the mean radial height H being equal to 44 mm and the mean circumferential length B being equal to 124 mm Under such conditions, the product TEVL*(H/B) is equal to 0.22, and therefore less than 0.35, according to the invention.

In addition, in a circumferential plane positioned axially in the tread portion as depicted in FIG. 4, outside of the circumferential groove, the circumferential void ratio TEC1 when new is equal to 38% and the circumferential void ratio TEC2 when worn is equal to 17%, and therefore TEC1 is equal to 2.24 times TEC2, and therefore greater than 1.45 times TEC2, according to a preferred embodiment of the invention.

In comparison with an agricultural-vehicle tire of the prior art, with a lugged tread and a metal crown reinforcement, and operating at low pressure, such as an IF (Improved Flexion) tire or a VF (Very high Flexion) tire, the inventors have observed an improvement in the endurance of the crown reinforcement for a tire with a tread having low circumferential tilt as described in the invention.

1. A tire for an agricultural vehicle, having a nominal section width L, within the meaning of the ETRTO standard, and comprising, radially from the outside to the inside, a tread and a crown reinforcement;
the tread comprising tread pattern elements that are separated from one another by voids and extend radially towards the outside from a bearing surface to a tread surface,
the tread having a volumetric void ratio TEV, defined as the ratio between the volume of voids VC and the total volume of the tread assumed to be free of voids V, comprised between the bearing surface and the tread surface,
each tread pattern element having a circumferential slenderness H/B, H being the mean radial height between the bearing surface and the tread surface and B being the mean circumferential length of the tread pattern element,
each tread portion, positioned axially, with respect to an equatorial plane (E) of the tire, at an axial distance DE, having an axial width LE and a local volumetric void ratio TEVL, defined as being the ratio between the volume VCL of the voids and the total volume VL of said tread portion, comprised between the bearing surface and the tread surface,
the crown reinforcement comprising at least two crown layers, each comprising metal reinforcers that are coated in an elastomeric material, are mutually parallel and form an angle at least equal to 10° with a circumferential direction (XX′),
wherein, for each tread portion positioned axially, with respect to the equatorial plane (E) of the tire, at an axial distance DE at most equal to 0.36*L, and having an axial width LE equal to 0.08*L, the product TEVL*(H/B) of the local volumetric void ratio of the tread portion and the circumferential slenderness H/B of each tread pattern element of said tread portion is at most equal to 0.35.

2. The tire according to claim 1, wherein the volumetric void ratio TEV of the tread is at least equal to 35%.

3. The tire according to claim 1, wherein the mean radial height H of each tread pattern element is at least equal to 20 mm.

4. The tire according to claim 1, wherein the mean radial height H of each tread pattern element is at most equal to 50 mm.

5. The tire according to claim 1, having, in a given circumferential plane (XZ), a circumferential void ratio TEC1 in the new state, measured along the curve (C1) of intersection between the circumferential plane (XZ) and the tread surface in the new state, TEC1 being defined as the ratio between the circumferential void length LC1 and the total circumferential length L1, and the tire having, in the circumferential plane (XZ), a circumferential void ratio TEC2 in the worn state, measured along the curve (C2) of intersection between the circumferential plane (XZ) and the tread surface in the worn state, the tread surface in the worn state being radially positioned on the outside of the bearing surface at a radial distance HR, TEC2 being defined as the ratio between the circumferential void length LC2 and the total circumferential length L2, wherein, in each circumferential plane (XZ) axially positioned at at most 0.4*L, the circumferential void ratio TEC1 in the new state is at least equal to 1.45 times the circumferential void ratio TEC2 in the worn state.

6. The tire according to claim 1, wherein the tread is made up of at least 5 circumferential rows of tread pattern elements that are separated from one another by substantially circumferential voids extending around the entire circumference of the tire, wherein the tread comprises transverse voids extending continuously from one axial edge of the tread to the other.

7. The tire according to claim 1, wherein the tread is made up of at least 5 circumferential rows of tread pattern elements that are separated from one another by substantially circumferential voids extending around the entire circumference of the tire, wherein the tread comprises transverse voids extending discontinuously from one axial edge of the tread to the other, such that the tread pattern elements of a given circumferential row have an angular offset in the circumferential direction (XX′) with respect to those of an adjacent row.

8. The tire according to claim 1, wherein the tread comprises a total number N of tread pattern elements, each tread pattern element comprising a contact face, a leading face and a trailing face, said leading face being inclined by an angle A towards the rear with respect to the radial direction (ZZ′) in the direction of running (R) of the tread, said tread comprising a number N1 of tread pattern elements for which the angle α is comprised between 50 degrees and 75 degrees, the number N1 being at least equal to 0.2×N.

9. The tire according to claim 1, wherein any metal reinforcer of a crown layer has a law, known as a bi-modulus law, governing its elastic behaviour under tension, and comprising a first portion having a first extension modulus MG1 at most equal to 30 GPa, and a second portion having a second extension modulus MG2 at least equal to 2 times the first extension modulus MG1, said law governing the tensile behaviour being determined for a metal reinforcer coated in an elastomer compound having a tensile elastic modulus at 10% elongation, MA10, at least equal to 5 MPa and at most equal to 15 MPa, and wherein any metal reinforcer of a crown layer has a law governing its behaviour under compression that is characterized by a critical buckling strain E0 at least equal to 3%, said law governing behaviour under compression being determined on a test specimen made up of a reinforcer placed at its centre and coated with a parallelepipedal volume of an elastomer compound having a tensile elastic modulus at 10% elongation, MA10, at least equal to 5 MPa and at most equal to 15 MPa.
